(19) United States
(12) Patent Application Publication
(10) Pub. No.: US 2026/0195856 A1
(43) Pub. Date: Jul. 9, 2026

(54) SYSTEMS AND METHODS OF ENHANCING IMAGES BY BLENDING INFRARED AND OPTICAL FEATURES

(71) Applicant: Valeo Schalter und Sensoren GmbH, Bietigheim-Bissingen (DE)

(72) Inventors: Sree Harsha Chowdary Gorantla, Troy, MI (US); Deep Doshi, Troy, MI (US); Jose Carlos Marti Monter, Troy, MI (US)

(21) Appl. No.: 19/008,820

(22) Filed: Jan. 3, 2025

(51) Int. Cl. G06T 5/50; G06V 10/75; G06V 10/77

(52) U.S. Cl. CPC G06T 5/50; G06V 10/751; G06V 10/7715; G06T 2207/10024; G06T 2207/10048; G06T 2207/20212

(57) ABSTRACT

Systems and methods for enhancing images by blending infrared and optical features includes an infrared camera capturing infrared images and an optical color camera capturing optical images of the same scene. A processor executes object detection on both image types, extracts features from detected objects, and compares these features. Based on the comparison, the processor assigns a blending percentage that includes proportions of infrared and optical features. The system outputs a blended image using the assigned blending percentage. The system improves visibility and object detection in low-light conditions, enhancing overall driving safety.

### TECHNICAL FIELD

The present disclosure relates to systems and methods of enhancing images by blending infrared and optical features.

### BACKGROUND

In modern vehicles, ensuring safety during night-time driving or in poor lighting conditions is important. Traditional cameras, commonly used for collision avoidance systems, often struggle to detect potential hazards effectively in low-light environments. This limitation can lead to increased risk of accidents as drivers might not see potential hazards in their path. Current problems include limited visibility in low light, multiple displays issue, integration challenges, and lack of recognition and enhancement.

### SUMMARY

In an embodiment, a system of enhancing images by blending infrared and optical features includes a first camera configured to capture infrared images of a scene, a second camera configured to capture optical images of the scene, and a processor. The processor is programmed to: execute object detection on the infrared images to detect an object in the infrared images; execute object detection on the optical images to detect the object in the optical images; extract features from the detected object in the infrared images; extract features from the detected object in the optical images; compare the extracted features from the infrared images with the extracted features from the optical images; assign a blending percentage based on the comparison of the features, wherein the blending percentage includes a percentage of infrared features and a percentage of optical features; and output a blended image of the object using the assigned blending percentage.

In another embodiment, a method of enhancing images by blending infrared and optical features comprises: capturing thermal images of a scene using a first camera; capturing optical images of the scene using a second camera different than the first camera; executing object detection on both the thermal images and the optical images using a processor in order to detect an object; extracting features from the detected object in each of the thermal images and the optical images using the processor; comparing the extracted features from the thermal images and the optical images using the processor; dynamically assigning a blending percentage for the detected object based on the comparison of the features, wherein the blending percentage includes a proportion of the thermal features and a proportion of the optical features; and generating a blended image of the scene using the assigned blending percentages for the detected object.

In another embodiment, non-transitory computer-readable medium storing instructions for enhancing images by blending infrared and optical features, wherein the instructions, when executed by a processor, cause the processor to perform steps comprising: capturing thermal images of a scene using a first camera; capturing optical images of the scene using a second camera different than the first camera; executing object detection on both the thermal images and the optical images using a processor in order to detect an object; extracting features from the detected object in each of the thermal images and the optical images using the processor; comparing the extracted features from the thermal images and the optical images using the processor; dynamically assigning a blending percentage for the detected object based on the comparison of the features, wherein the blending percentage includes a proportion of the thermal features and a proportion of the optical features; and generating a blended image of the scene using the assigned blending percentages for the detected object.

### BRIEF DESCRIPTION OF THE DRAWINGS

FIG. 1 illustrates a schematic of a vehicle having a vehicle camera system including a plurality of vehicle cameras, according to an embodiment.

FIG. 2A illustrates an example of an image taken from a visible-light (RGB) camera in low-light conditions of a scene, according to an embodiment.

FIG. 2B illustrates the same scene as FIG. 2A except with the image taken from an infrared camera.

FIG. 3 illustrates a blended image of the scene, using features of the infrared image blended with the RGB image, according to an embodiment.

FIG. 4 illustrates a flow chart of a method of enhancing images by blending infrared and optical features, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

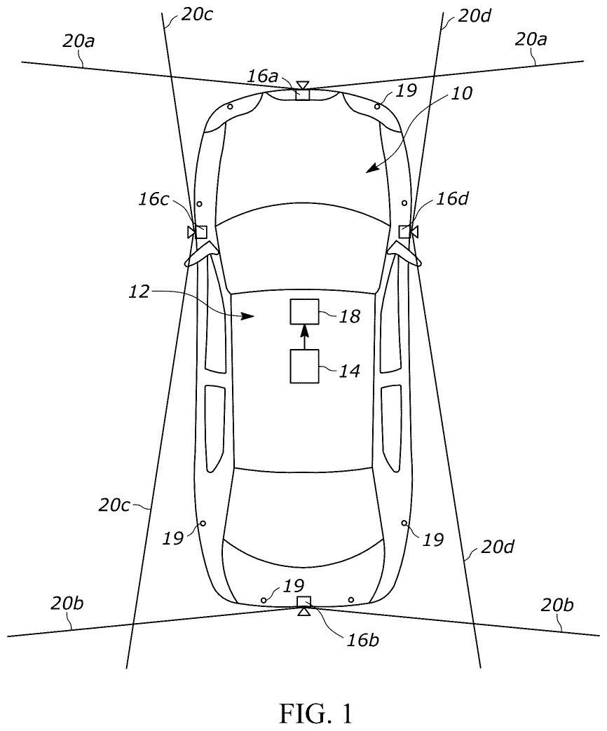

Additionally, it should be understood that in this disclosure, the term “camera” includes both optical cameras (also known as visible light cameras or RGB cameras) and infrared cameras (also known as thermal cameras or thermal images cameras). Optical cameras and infrared cameras operate using distinct principles to capture visual data. Optical cameras rely on visible light to produce images, capturing the wavelengths of light that the human eye can perceive. In contrast, infrared cameras detect infrared radiation, which is emitted by objects as heat, enabling visualization of features in low-light or obscured conditions that are invisible to optical cameras. While their underlying technologies differ, both types of cameras serve as sensors that collect complementary data for robust object detection and feature fusing. For simplicity and consistency, the term “cameras” will be used herein to collectively refer to both optical and infrared cameras unless otherwise specified. Referring to FIG. 1, which is described further below, each of the cameras 16a-d can be or include either or both of an optical camera and/or an infrared camera.

In modern vehicles, ensuring safety during night-time driving or in poor lighting conditions is important. Traditional RGB cameras, commonly used for collision avoidance systems, often struggle to detect objects and pedestrians effectively in low-light environments. This limitation can lead to an increased risk of accidents as drivers might not see potential hazards in their path. The need for enhanced visibility and object detection in such conditions is essential to improving overall driving safety.

Current solutions face several problems. Limited visibility in low light remains a significant challenge, as traditional RGB cameras do not perform well in these conditions. Additionally, the use of multiple displays to present different types of imaging data can create visual clutter and distract the driver. Integration challenges also arise when attempting to combine data from different imaging systems. Furthermore, existing systems often lack robust object recognition and enhancement capabilities, which are crucial for accurately identifying and displaying potential hazards.

The proposed system addresses these issues by enhancing images through the blending of infrared and optical features. The system comprises an infrared camera configured to capture infrared images of a scene and an optical color camera configured to capture optical images of the same scene. A processor, programmed to execute object detection on both the infrared and optical images, extracts features from the detected objects in each type of image. By comparing these extracted features, the processor assigns a blending percentage that includes a proportion of infrared and optical features. The system then outputs a blended image of the object using the assigned blending percentage, providing a more comprehensive and clear representation of the scene. This approach ensures improved visibility and object detection in low-light conditions, enhancing overall driving safety.

FIG. 1 illustrates a schematic of a vehicle 10 according to an embodiment, shown here from a top view. The vehicle 10 shown is a passenger car, but the vehicle can be other types of vehicles such as a truck, van, or sports utility vehicle (SUV), or the like. The vehicle 10 includes a camera system 12 which includes an electronic control unit (ECU) 14 connected to a plurality of cameras 16a, 16b, 16c, and 16d. In general, the ECU 14 includes one or more processors programmed to process the images data associated with the cameras 16a-d and generate a composite top view on a vehicle display 18. In some embodiments, the vehicle 10 also includes a plurality of proximity sensors (e.g., ultrasonic sensors, radar, sonar, LiDAR, etc.) 19. The proximity sensors 19 can be connected to their own designated ECU that develops a sensor map of objects external to the vehicle. Alternatively, the proximity sensors can be connected to ECU 14. The output of the proximity sensors 19 can be fused with the output of the cameras 16a-d for object detection disclosed herein, for example.

The ECUs disclosed herein may more generally be referred to as a controller. In the case of an ECU 14 of a camera system 12, the ECU can be capable of receiving image data from the various cameras (or their respective processors), processing the information, and outputting instructions to combine the image data in generating a composite top view, for example. In the case of an ECU associated with the proximity sensors 19, the ECU can be capable of receiving sensor data from the various proximity sensors (or their respective processors), processing the information, and outputting a sensor map of objects surrounding the vehicle; this ECU can also be capable of causing alerts to be sent to the driver during driving or parking maneuvers that might warn the driver of the proximity of the detected objects. In this disclosure, the terms “controller” and “system” may refer to, be part of, or include processor hardware (shared, dedicated, or group) that executes code and memory hardware (shared, dedicated, or group) that stores code executed by the processor hardware. The code is configured to provide the features of the controller and systems described herein. In one example, the controller may include a processor, memory, and non-volatile storage. The processor may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory. The memory may include a single memory device or a plurality of memory devices including, but not limited to, random access memory (“RAM”), volatile memory, non-volatile memory, static random-access memory (“SRAM”), dynamic random-access memory (“DRAM”), flash memory, cache memory, or any other device capable of storing information. The non-volatile storage may include one or more persistent data storage devices such as a hard drive, optical drive, tape drive, non-volatile solid-state device, or any other device capable of persistently storing information. The processor may be configured to read into memory and execute computer-executable instructions embodying one or more software programs residing in the non-volatile storage. Programs residing in the non-volatile storage may include or be part of an operating system or an application, and may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL. The computer-executable instructions of the programs may be configured to, upon execution by the processor, cause the harmonization techniques and algorithms described herein.

In the embodiment illustrated in FIG. 1, the cameras 16-d are located about different quadrants of the vehicle, although more than four cameras may be provided in the camera system 12. Each camera 16a-d may have a fish-eye lens to obtain images with an enlarged field of view, indicated by boundary lines 20a-d. In an example, a first camera 16a faces an area in front of the vehicle, and captures images with a field of view indicated by boundary lines 20a. The first camera 16a can therefore be referred to as the front camera. A second camera 16b faces an area behind the vehicle, and captures images with a field of view indicated by boundary lines 20b. The second camera 16b can therefore be referred to as the rear camera. A third camera 16c faces an area on the left side of the vehicle, and captures images with a field of view indicated by boundary lines 20c. The third camera 16c can therefore be referred to as the left camera, or left-side camera. The third camera 16c can also be mounted on or near the vehicle's left wing mirror, and can therefore be referred to as a mirror left (ML) camera. A fourth camera 16d faces an area on the right side of the vehicle, and captures images with a field of view indicated by boundary lines 20d. The fourth camera 16d can therefore be referred to as the right camera, or right-side camera. The fourth camera 16d can also be mounted on or near the vehicle's right wing mirror, and can therefore be referred to as a mirror right (MR) camera. The images (or the associated image data) originating from the cameras 16a-d can be processed by the ECU 14 (e.g., stitched together, distorted, combined, and harmonized) to generate the composite top view on the vehicle display 18.

In an embodiments, each of the camera 16a-d includes both an infrared camera and an optical camera, and thus there are eight cameras in all. Of course, the present disclosure is not limited to eight cameras, as more or less can be provided. At each of the illustrated cameras 16a-d, there may be both an optical camera and an infrared camera. Both of these cameras at a single location can be aligned with one another such that they have the same (or similar) field of view. The system described herein can include software that warps the images to make the infrared images and the optical images fit with one another and have the same scene such that an object appearing in the infrared image appears in the same location of the scene in the optical image.

The vehicle display 18 can include various types of screens and interfaces within a vehicle that present visual information to the driver and passengers. These can include, but are not limited to the following types of displays: an infotainment display, which is the central screen typically located on the dashboard used for navigation, media, and other vehicle controls; a head-up display (HUD), a transparent display that projects information onto the windshield, allowing the driver to see data without looking away from the road; an instrument cluster display, located behind the steering wheel, showing critical driving information such as speed, fuel level, and warning indicators; a rearview mirror display, integrated into the rearview mirror and often used for displaying the feed from a rearview camera; side mirror displays, integrated into the side mirrors and used for showing camera feeds or other relevant information; and passenger displays, additional screens available for passengers, often used for entertainment or navigation assistance (which can include displays integrated into the vehicle and/or external displays such as smartphones communicatively connected to the vehicle). These displays can be used to present the blended images generated by the system, enhancing visibility and object detection for improved driving safety.

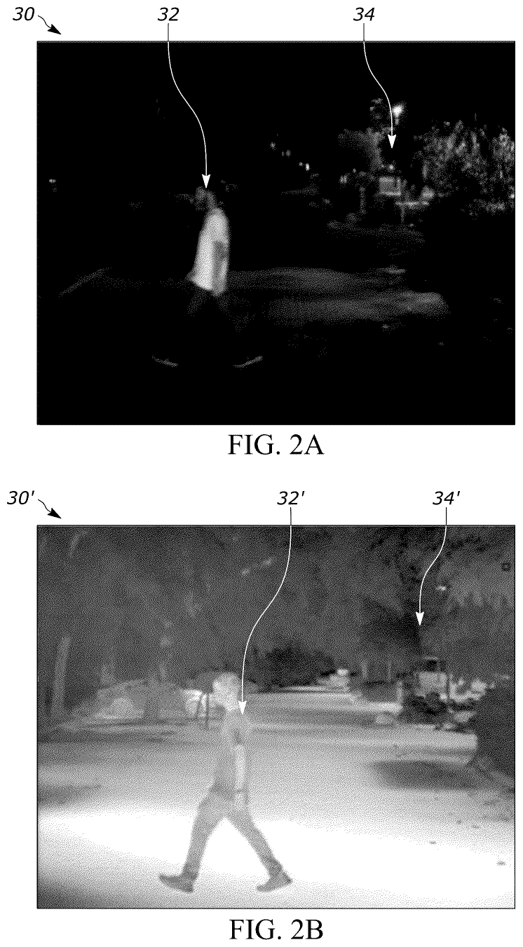

FIG. 2A shows an example of an image of a scene 30 captured by an optical camera (e.g., one of the cameras 16a-d) under low-light conditions. The scene 30 depicted includes an object 32 (in this case, a person) walking across a street near the vehicle 10. The background 34 of the image is barely visible due to the poor lighting conditions, which significantly limits the visibility of the surroundings. The faint appearance of the person in the image highlights the challenges faced by traditional RGB cameras in detecting objects effectively in low-light environments. This figure illustrates the limitations of relying solely on optical cameras for object detection in such conditions, as the person is barely discernible, posing a potential risk for collision avoidance systems in vehicles. Moreover, if just an RGB image was displayed on the vehicle display 18, the person looking at the vehicle display would barely be able to see the person due to the poor lighting conditions.

FIG. 2B shows an image of the same scene as depicted in FIG. 2A, except this scene 30′ is captured by an infrared camera (e.g., another one of the cameras 16a-d). The scene 30′ includes the object 32′, again this time a person walking across a street near the vehicle 10, along with the background 34′. Compared to the optical image in FIG. 2A, the infrared image of FIG. 2B provides a clearer depiction of the person and the background 34, due to the low-light environment.

The infrared camera captures the thermal radiation emitted by objects, which enhances visibility in low-light conditions. The person in the image is more discernible, and the background details are more visible compared to the optical image. This improved visibility is due to the infrared camera's ability to detect heat signatures, which are not dependent on ambient light. This image demonstrates the capability of infrared cameras to provide clearer images in low-light conditions, making detection of objects and pedestrians easier. The infrared image, while lacking color information, offers a significant improvement in object detection and scene clarity. Portions of this thermal image can be fused or blended with the RGB image from FIG. 2A (as will be described further below) to create a composite image that leverages the strengths of both imaging technologies. This fusion process enhances the overall visibility and object detection capabilities, providing a more comprehensive and clear representation of the scene for the driver.

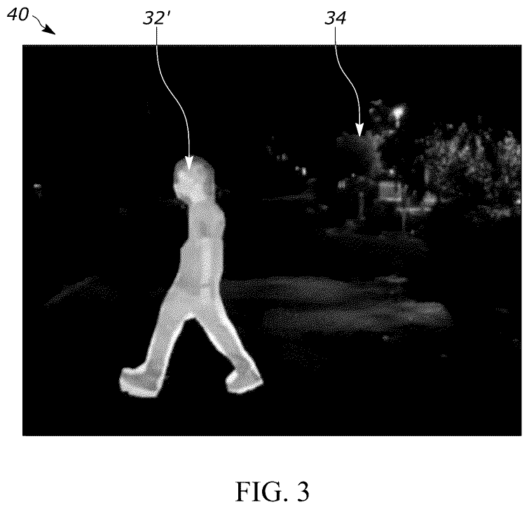

FIG. 3 shows a blended image 40 of the same scene of FIGS. 2A-B, using features of the infrared image blended with the RGB image, according to an embodiment. The blended image integrates data from both the infrared camera and the optical color camera. In embodiments, as will be further described, the processor extracts features from both the RGB image and the thermal image. The processor then compares these features, such as color contrast, brightness, and edge clearness. Based on this comparison, the processor assigns a blending percentage that includes a proportion of infrared and optical features. The blending percentage can be dynamically decided in real-time based on which camera has more segmented features for the detected object.

The resultant blended image shows the person more clearly, leveraging the strengths of both imaging technologies. In particular, the blended image includes the object (in this case a person) 32′ based on data from the thermal image (FIG. 2B), and the background 34 from the visible camera. The thermal data enhances the visibility of the object, making the object more discernible against the low-light background. This fusion process provides a more comprehensive and clear representation of the scene, improving object detection capabilities and overall visibility for the driver.

The blended image can be displayed on a single vehicle infotainment display, eliminating the need for multiple screens and reducing visual clutter. This approach ensures that objects detected by the thermal camera are recreated and shown in real-time within the RGB image, providing a more intuitive and safer driving experience.

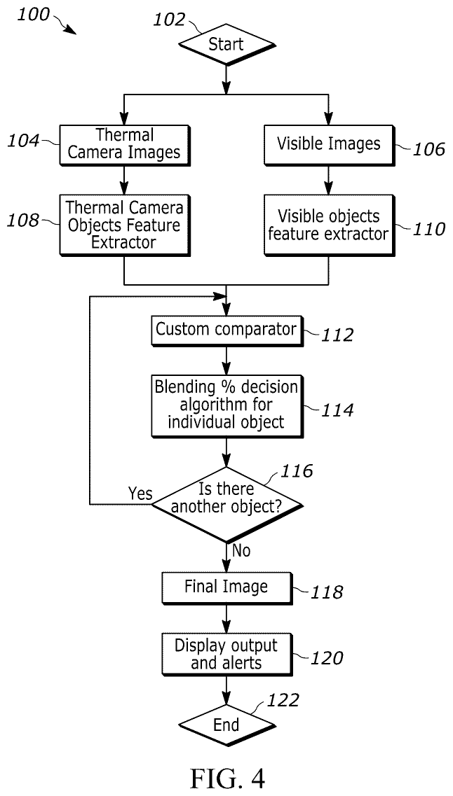

FIG. 4 illustrates a flowchart of a method 100 for enhancing images by blending infrared and optical features. The method can be executed by the system shown in FIG. 1, namely the ECU, including its processors and memory. For example, one or more processors of the ECU 14 may be programmed, based on instructions stored in memory, to perform the steps shown in FIG. 4. As will be described further below, the process begins with the initialization of the system, followed by the simultaneous capture of thermal and visible images. Features are then extracted from both the thermal and visible images. These extracted features are compared using a custom comparator. Based on the comparison, a blending percentage is determined for each individual object within the images. The method checks if there are additional objects to process and, if so, repeats the blending percentage decision process for each object. Once all objects have been processed, a final blended image is generated. This final image is then displayed along with any relevant alerts, concluding the process.

The method starts at 102 with the initialization of the system. This step involves starting the process of enhancing images by blending infrared and optical features. It can ensure that all necessary components, including the thermal camera and the optical color camera, are ready to capture images of the scene. The processor is also prepared to execute the required algorithms for object detection, feature extraction, and image blending. In embodiments, the method starts at 102 in response to a particular vehicle system or setting being enabled, such as a parking assistance system or other Advanced Driver Assistance Systems (ADAS).

The method proceeds by receiving thermal camera images of the scene taken from the thermal camera (e.g., one of the cameras 16a-d) at 104. This step involves capturing infrared images that detect thermal radiation emitted by objects within the camera's field of view, such as shown in FIG. 2B. These images can provide a clear depiction of objects and their surroundings, even in low-light or obscured conditions.

Simultaneously, at 106, the method receives visible images of the same scene taken from the optical color camera (e.g., another one of the cameras 16a-d). This step involves capturing optical images that rely on visible light to produce images, capturing the wavelengths of light that the human eye can perceive, such as shown in FIG. 2A. These images provide color information and visual details of the scene under various lighting conditions.

At 108, the method includes extracting features from the thermal camera images using a thermal camera objects feature extractor. This step involves executing object detection algorithms on the infrared images to identify objects within the scene. Once the objects are detected, features such as contours, edges, and other thermal characteristics are extracted from the detected objects. These features are then transmitted to the processor for further comparison.

Similarly, at 110, the method extracts features from the visible images using a visible objects feature extractor. This step involves executing object detection algorithms on the optical images to identify objects within the scene. Once the objects are detected, features such as color contrast, brightness, and edge clearness are extracted from the detected objects. These features are then transmitted to the processor for comparison with the features extracted from the thermal images.

In embodiments, a machine-learning (ML) model, such as a convolutional neural network (CNN), is trained specifically for identifying objects based on thermal image data. The training dataset can include a variety of thermal images with labeled objects, such as pedestrians, vehicles, and other potential hazards. The model learns to identify and classify these objects based on their thermal signatures, which are characterized by heat patterns and contours. During operation, the thermal camera captures images of the scene, and the ML model processes these images to detect objects. The model extracts features such as edges, shapes, and thermal gradients, which are indicative of the objects'presence and positions. The detected objects are then highlighted and their features are transmitted to the processor for further analysis and comparison with features from the visible images.

Likewise, in embodiments, a separate ML model, also potentially a CNN, is trained specifically for identifying objects based on visible light image data. The training dataset can include a wide range of optical images with labeled objects under various lighting conditions, including low-light scenarios. The model learns to recognize and classify objects based on visual features such as color, texture, and brightness. When the optical color camera captures images of the scene, the ML model processes these images to detect objects. The model extracts features such as color contrast, brightness, and edge clearness, which help in identifying and classifying the objects. These detected objects and their features are then transmitted to the processor for comparison with the features extracted from the thermal images.

In some embodiments, a unified ML model is trained to process both thermal and visible images simultaneously. This model leverages a multi-modal dataset that includes paired thermal and visible images with labeled objects. The training process involves learning to detect and classify objects by combining features from both types of images. During operation, the unified model receives both thermal and visible images of the scene. It processes these images concurrently, extracting and fusing features from both modalities. The model compares the features to identify objects with higher accuracy and robustness. This combined approach ensures that the strengths of both thermal and visible imaging technologies are utilized, enhancing object detection capabilities in various lighting conditions.

In these object-detection embodiments, the processor can be programmed for dynamically comparing the features extracted by the ML models from both thermal and visible images. Based on this comparison, the processor assigns a blending percentage that includes a proportion of infrared and optical features. The blending percentage can be dynamically decided in real-time, ensuring that the final blended image leverages the most informative features from both imaging technologies.

As explained above, a ML model such as a CNN can be used to perform the object detection and feature extracting. A CNN is a type of deep learning model specifically designed for processing structured grid data, such as images. The structure of a CNN includes several layers, each serving a distinct purpose in the feature extraction and classification process. The input layer receives the raw image data. For thermal images, this would be the pixel values representing heat signatures, while for visible images, it would be the RGB pixel values. Convolutional layers apply convolutional filters to the input image to detect various features. Each filter is a small matrix that slides over the image, performing element-wise multiplication and summing the results to produce a feature map. In the context of thermal images, the filters might detect edges, contours, and thermal gradients. For visible images, the filters might detect color contrasts, textures, and shapes. After each convolutional layer, an activation function (e.g., ReLU—Rectified Linear Unit) can be applied to introduce non-linearity into the model. This helps the network learn complex patterns. The activation function ensures that only the most relevant features are passed on to the next layer, enhancing the model's ability to detect objects in both thermal and visible images. Pooling layers reduce the spatial dimensions of the feature maps, retaining the most important information while reducing computational complexity. Common pooling methods include max pooling and average pooling. This step helps in making the model more robust to variations in the input images, such as changes in scale or orientation. Fully connected layers are similar to traditional neural networks and are used to combine the features extracted by the convolutional and pooling layers. They help in making final predictions about the presence and classification of objects. For thermal images, the fully connected layers might focus on combining thermal features to identify objects based on their heat signatures. For visible images, they might combine visual features to classify objects based on their appearance. The output layer provides the final predictions, such as the class labels of detected objects. In the case of object detection, it might also include bounding box coordinates to indicate the location of the objects within the image.

In addition to CNNs, other types of ML models can be employed for object detection in thermal and visible images. One such model is the recurrent neural network (RNN), which is particularly effective for sequential data and can be adapted for video-based object detection by analyzing frames over time. Another model is the support vector machine (SVM), which can be used for classification tasks by finding the optimal hyperplane that separates different classes in the feature space. Decision trees and their ensemble variants, such as random forests and gradient boosting machines, are also viable options for object detection, as they can handle complex decision boundaries and interactions between features. Additionally, autoencoders, a type of unsupervised learning model, can be used for feature extraction and anomaly detection by learning a compressed representation of the input data. These alternative ML models offer various advantages and can be selected based on the specific requirements and constraints of the object detection task in thermal and visible images.

Regarding the aforementioned edge detection, Canny edge detection can be used in embodiments. Canny edges is an example of an edge detector that is used in image processing to identify the boundaries of objects within an image. The Canny edge detection algorithm operates through a multi-stage process to achieve accurate and reliable edge detection. First, the image is smoothed using a Gaussian filter to reduce noise and unwanted details. Next, the algorithm calculates the gradient intensity and direction at each pixel using techniques such as the Sobel operator. This step highlights regions with high spatial derivatives, indicating potential edges. The algorithm then applies non-maximum suppression to thin out the edges, ensuring that only the most prominent edge pixels are retained. Following this, double thresholding is used to classify edge pixels into strong, weak, and non-edges based on their gradient intensity. Finally, edge tracking by hysteresis is performed, where weak edges connected to strong edges are preserved, while isolated weak edges are discarded. This comprehensive approach allows the Canny edge detector to effectively identify and delineate object boundaries, making it a valuable tool for feature extraction in both thermal and visible images.

Referring back to FIG. 4, step 112 involves comparing the features extracted from both the thermal and visible images to determine the most informative features for each detected object. This step enables dynamically assigning a blending percentage (step 114) that optimally combines the strengths of both imaging modalities. The custom comparator analyzes features such as color contrast, brightness, edge clearness, contours, and thermal gradients. Additionally, other features that can be analyzed include texture, shape, size, motion patterns, and spatial relationships between objects. For instance, if the thermal image offers clearer contours and thermal gradients for a pedestrian, while the visible image provides better color contrast and brightness for a vehicle, the algorithm assigns a higher blending percentage to the thermal features for the pedestrian and to the optical features for the vehicle. By evaluating these features, the comparator identifies which imaging modality—thermal or visible—provides the most detailed and accurate representation of each object. The analysis can be performed in real-time, such that the blending percentage may change during a live view of the scene based on, for example, changing lighting conditions, movement of the object, and the like. Based on this analysis, the custom comparator at 112 assigns a blending percentage that includes a proportion of infrared and optical features, ensuring that the final blended image leverages the most informative features from both types of images. This dynamic comparison and blending process enhances the overall visibility and object detection capabilities, providing a more comprehensive and clear representation of the scene for the driver.

In embodiments, the system dynamically adjusts the blending percentage based on the classification of objects detected in the infrared and optical images. For instance, when the object identified is a pedestrian, the system can assign a higher blending percentage to the infrared features (e.g., 60% infrared, 40% visible) to enhance visibility in low-light conditions, ensuring the pedestrian is clearly visible. For vehicles, which may have more distinct features in optical images and which may have different heat signatures than pedestrians, the system can assign a higher blending percentage to the optical features (e.g., 30% infrared, 70% visible). Of course these percentages are merely an embodiment illustrating the general concept that these percentages can be adjusted based on the classification. This dynamic adjustment ensures that the most relevant features are highlighted for different types of objects, enhancing overall image clarity and safety.

In embodiments, the object is only classified in one of the cameras (e.g., either the infrared camera or the optical camera). Because both images can be aligned with one another as described above, the corresponding section of area of the scene from one camera can be cut out from the image from the camera where the object was not classified. This is because sometimes the object may not be classified but some features may be still shown, like hands, shirt, contrast, etc.

In other embodiments, the system can utilize a ML model to continuously learn and improve the blending percentage based on real-time data and feedback. This model can analyze various environmental factors such as lighting conditions, weather, and the presence of multiple objects, adjusting the blending percentage accordingly. For example, during foggy conditions, the system can increase the blending percentage of infrared features to penetrate the fog and provide a clearer image.

In a further embodiment, the system could incorporate user preferences or manual adjustments. Drivers could have the option to manually adjust the blending percentages through a user interface, allowing them to customize the image output based on their personal preferences or specific driving conditions. This could be particularly useful in scenarios where the driver has a preference for more thermal or optical features based on their comfort and visibility needs.

In yet another embodiment, the system could be designed to operate in various modes depending on the driving environment. For example, an “urban mode” could prioritize optical features to better capture traffic lights and road signs, while a “rural mode” could prioritize infrared features to detect wildlife and other obstacles in low-light conditions. This adaptability ensures that the system provides optimal performance across different driving scenarios.

Returning back to FIG. 4, at step 116, the method includes determining whether there are additional objects within the scene that need to be processed. This step ensures that all detected objects in the captured images undergo the feature comparison and blending percentage assignment process. Specifically, the system checks if there are any more objects that have not yet been analyzed by the custom comparator. If the system identifies that there is another object to process, it returns to step 112, where the custom comparator analyzes the features extracted from both the thermal and visible images for the next object. This iterative process allows the system to dynamically and accurately blend the infrared and optical features for each individual object within the scene. By repeatedly returning to step 112 for each detected object, the method ensures that every object is individually evaluated and assigned an optimal blending percentage based on its specific features. This approach enhances the overall visibility and object detection capabilities, providing a more detailed and accurate representation of the scene for the driver. If there are no additional objects to process, the method proceeds to step 118.

At step 118, the method includes generating the final blended image based on the blending percentages assigned to each detected object. After all objects within the scene have been processed and their respective blending percentages determined, the system combines the infrared and optical features according to these percentages. This step ensures that the final image leverages the most informative features from both thermal and visible images, providing a comprehensive and clear representation of the scene. This image can then be prepared for display at 120, offering improved clarity and detail for the driver.

In embodiments, generation of the final blended image can include placing the blended object back into the original RGB image. For example, the blended object, which now includes enhanced features from both the infrared and RGB images, is overlaid onto the scene captured by the RGB camera. In simpler terms, overlaying the blended object means taking the enhanced version of an object (created by combining thermal and optical data) and placing the enhanced version of an object back into the regular color image of the scene. The overlay can rely on aligning the detected edges of each image, ensuring that the enhanced features seamlessly integrate into the RGB scene. The result is an image where the objects are more visible and discernible, especially in low-light conditions.

In other embodiments, generation of the final blended image can include placing the blended object onto a blended scene that replaces the original RGB image. In other words, more than just the object can be blended. Instead, the processes described herein can be performed on both foreground and background objects that are in the scene, and other segregated areas in the scene. A dynamic adjustment of the blending percentage can be made for each detected object, depending on its classification and extracted features, for example. Some areas of, or objects in, the scene may be not classified, such as the clouds, sky, vegetation, etc. In such situations, these non-classified areas of the image can be treated by the system as a separate object or zone with its own corresponding dynamic blending. Thus, in embodiments, the entire final image output can be a blended final image, and this can occur regardless of whether an object is classified or not.

At 120, the method includes displaying the final blended image along with any relevant alerts on the vehicle display 18. The final image is presented in a manner that enhances visibility and object detection for the driver, reducing visual clutter and providing a more intuitive driving experience. Additionally, any alerts related to detected objects or potential hazards can be displayed alongside the final image, ensuring that the driver is informed of critical information in real-time. The method ends at 122.

Additionally or alternatively to the image being displayed, this final image can be prepared for further processing, such as for downstream systems (e.g., ADAS) that may rely on a blended thermal and visible-light image. ADAS can benefit from the enhanced visibility and object detection capabilities provided by the blended image. By leveraging the strengths of both thermal and visible imaging technologies, the blended image offers a more comprehensive and accurate representation of the scene, which can be crucial for various ADAS functionalities. For instance, lane departure warning systems can use the blended image to detect lane markings more accurately in low-light conditions, while pedestrian detection systems can identify pedestrians more reliably by combining thermal signatures with visible features. Additionally, collision avoidance systems can benefit from the improved object detection capabilities, allowing for more precise identification of potential hazards and timely activation of emergency braking or steering maneuvers.

Beyond ADAS, other downstream systems can also benefit from the blended image. Autonomous driving systems, for example, require robust and reliable perception capabilities to navigate complex environments safely. The enhanced image can improve the system's ability to detect and classify objects, recognize traffic signs, and interpret road conditions, thereby enhancing the overall performance and safety of autonomous vehicles. Furthermore, driver monitoring systems can use the blended image to assess the driver's attention and alertness more effectively, ensuring that the driver remains engaged and responsive to the driving environment.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A system of enhancing images by blending infrared and optical features, the system comprising:
a first camera configured to capture infrared images of a scene;
a second camera configured to capture optical images of the scene; and
a processor programmed to:
execute object detection on the infrared images to detect an object in the infrared images;
execute object detection on the optical images to detect the object in the optical images;
extract features from the detected object in the infrared images;
extract features from the detected object in the optical images;
compare the extracted features from the infrared images with the extracted features from the optical images;
assign a blending percentage based on the comparison of the features, wherein the blending percentage includes a percentage of infrared features and a percentage of optical features; and
output a blended image of the detected object using the assigned blending percentage.

2. The system of claim 1, wherein the processor is further programmed to classify the object in either or both of the infrared images and optical images, wherein the blending percentage is assigned based on the classification of the object.

3. The system of claim 2, wherein the blending percentage changes based upon the classification of the object.

4. The system of claim 1, wherein the object includes a plurality of objects including a foreground object and a background object, and wherein the processor is programmed to dynamically adjust the blending percentage in real-time based on features detected in the infrared images and the optical images for each of the foreground object and the background object.

5. The system of claim 1, wherein the processor is further programmed to dynamically adjust the blending percentage in real-time based on features detected in the infrared images and the optical images.

6. The system of claim 1, wherein the processor is further programmed to execute Canny edge detection to extract the features from the detected object in the infrared images or the optical images.

7. The system of claim 1, wherein the processor is further programmed to output the blended image to at least one downstream Advanced Driver Assistance System (ADAS).

8. The system of claim 1, wherein the processor is further programmed to output the blended image to a vehicle display.

9. The system of claim 1, wherein the processor is further programmed to output the blended image along with a blended version of the scene onto the vehicle display.

10. A method of enhancing images by blending infrared and optical features, the method comprising:
capturing thermal images of a scene using a first camera;
capturing optical images of the scene using a second camera different than the first camera;
executing object detection on both the thermal images and the optical images using a processor in order to detect an object;
extracting features from the detected object in each of the thermal images and the optical images using the processor;
comparing the extracted features from the thermal images and the optical images using the processor;
dynamically assigning a blending percentage for the detected object based on the comparison of the features, wherein the blending percentage includes a proportion of the thermal features and a proportion of the optical features; and
generating a blended image of the scene using the assigned blending percentage for the detected object.

11. The method of claim 10, further comprising displaying the blended image on a vehicle display.

12. The method of claim 10, further comprising classifying the object in both of the infrared images and optical images, wherein the blending percentage is assigned based on the classification of the object.

13. The method of claim 12, wherein the blending percentage changes based upon the classification of the object.

14. The method of claim 10, wherein the object includes a plurality of objects including a foreground object and a background object, and wherein the method further comprises dynamically adjusting the blending percentage in real-time based on features detected in the infrared images and the optical images for each of the foreground object and the background object.

15. The method of claim 10, wherein the blending percentage is assigned in real-time based on the extracted features in the infrared images and the optical images.

16. The method of claim 10, further comprising outputting the blended image along with a blended version of the scene onto the vehicle display.

17. The method of claim 10, further comprising outputting the blended image to at least one downstream vehicle system.

18. The method of claim 17, wherein the downstream vehicle system is an Advanced Driver Assistance System (ADAS).

19. A non-transitory computer-readable medium storing instructions for enhancing images by blending infrared and optical features, wherein the instructions, when executed by a processor, cause the processor to:
capture thermal images of a scene using a first camera;
capture optical images of the scene using a second camera different than the first camera;
execute object detection on both the thermal images and the optical images using a processor in order to detect an object;
extract features from the detected object in each of the thermal images and the optical images using the processor;
compare the extracted features from the thermal images and the optical images using the processor;
dynamically assign a blending percentage for the detected object based on the comparison of the features, wherein the blending percentage includes a proportion of the thermal features and a proportion of the optical features; and
generate a blended image of the scene using the assigned blending percentage for the detected object.

20. The non-transitory computer-readable medium of claim 19, wherein the instructions, when executed by the processor, further cause the processor to:
classify the object in either or both of the infrared images and optical images, wherein the blending percentage is assigned based on the classification of the object.
